(19) United States
(12) Patent Application Publication
(10) Pub. No.: US 2025/0163734 A1
(43) Pub. Date: May 22, 2025

(54) VEHICLE DOOR WITH AN EXTENDABLE HANDLE

(71) Applicant: Minebea AccessSolutions Italia S.p.A., Pianezza (IT)

(72) Inventors: Hervé Calor, Pianezza (IT); Alexandre Pieri, Pianezza (IT); Sachin Sharma, Pianezza (IT); Manu Sharma, Pianezza (IT); Paramjeet Sandhu, Pianezza (IT); Robert Kastner, Aach (DE); Pascal Thiel, Dauchingen (DE)

(21) Appl. No.: 18/945,701

(22) Filed: Nov. 13, 2024

(30) Foreign Application Priority Data
Nov. 16, 2023 (DE) 102023131992.2

(51) Int. Cl. E05B 85/10; E05B 85/18

(52) U.S. Cl. CPC E05B 85/107; E05B 85/18

(57) ABSTRACT

A vehicle door including a vehicle door lock to be actuated, which interacts with a handle and is configured to pivot about an axle which extends substantially in a longitudinal direction of the vehicle, and a recess in an outer door panel for the handle, wherein the handle is pivoted by an actuator into an extended position or into a retracted position, wherein the recess is arranged in an area of a window frame and the handle is received in the recess, and wherein, in the retracted position, the handle pivots at least partially behind the outer door panel.

### TECHNICAL FIELD

The present disclosure relates to a vehicle door. More specifically, the present disclosure relates to a vehicle door with an extendable handle.

### BACKGROUND

It is known that a vehicle door is equipped with a locking system that can be triggered by a mechanical device built into a handle of the vehicle. Typically, an operator would grasp the mechanical device located on the handle to trigger it. The operator would then pull on the vehicle door at the same time to open it. This is convenient in that the operator can operate the vehicle door intuitively, as the mechanical device responds to the gripping of the handle.

Some vehicles are equipped with a handle recessed into the vehicle door. These handles allow for a better aesthetic effect as they blend in with the rest of the vehicle door and are therefore very discreet. This type of handles also allows to improve the aerodynamics of the vehicle while driving, as they are flush with the vehicle door.

These recessed handles are available in mechanical and motorized versions.

The handle element is rotatable or displaceable with respect to a support between a rest position in which it is arranged substantially parallel to the support and recessed in the vehicle door (or flush with an outer surface of a door leaf), and an open position in which it is inclined relative to the vehicle door and thus extended.

The object of the present disclosure is to provide a compact handle on the vehicle, which achieves a reduction in air resistance and turbulence and enables more intuitive operation.

### SUMMARY

The present disclosure provides a vehicle door comprising a vehicle door lock to be actuated, which interacts with a handle which is configured to pivot about an axle which extends substantially in a longitudinal direction of the vehicle and has a recess in an outer door panel for the handle, wherein the handle can be moved into a extended position or pivots into a retracted position. For this purpose, the recess is arranged in an area of a window frame and the handle is received in the recess, wherein in the retracted position the handle pivots at least partially behind the outer door panel. By arranging the handle in the area of the window frame, which in other words defines that the recess is provided in the window frame, the door appears like a handle-free door, since there are no visible joints in the area of the outer door panel, in the area where the handles are usually located, as is the case with known extendable handles. Furthermore, the position of the handle is more intuitive and there is less turbulence. In addition, a corresponding handle in this position can be made significantly smaller and lighter than conventional handles. The window frame is the part of the vehicle door which, seen from the door outer side, defines the window opening and adjoins the window at the outer side (when the window closes the window opening).

In one design variant, there is no mechanical connection between the handle and an electric vehicle door lock. This has the advantage that no special installation space needs to be provided for the installation of a Bowden cable. Instead, all functions of the vehicle door lock are queried by sensors and converted into corresponding motor control commands. This eliminates the need for mechanical connecting levers, for example between an outside handle and an inside handle for locking the vehicle door. In addition, this also reduces the assembly time, since no Bowden cable needs to be attached, but only plug connections need to be connected to each other.

In a further embodiment, the actuator is either attached directly to the handle or integrated into it. In addition, a gear can be integrated directly on the handle or into it, so that the actuator can be dimensioned smaller. This further reduces the installation space required for the handle.

In a further embodiment, the actuator is arranged spatially separated from the handle and pivots the handle by actuating a transmission element. For example, the transmission element is moved linearly. The actuator can be a spindle drive with a spindle and spindle nut, wherein the spindle or the spindle nut is driven via a worm gear. The transmission element is connected either to the spindle or the spindle nut. In order to compensate for the angle between the handle and the transmission element when pivoting the handle, the transmission element has a receptacle near each of its two end faces, which is provided on the handle and on the spindle drive in order to connect the transmission element to the handle and the spindle drive. For example, the handle has at least one connecting element in the form of an axle. This allows for a smooth movement of the handle.

In a further embodiment, the transmission element can rotate about an axle and thereby pivot the handle from a retracted position to an extended position. For example, the transmission element is a bevel gear which is driven by the actuator. Furthermore, the transmission element can be a gear which is driven via a bevel gear. Thus, a bevel gear or a gear can be connected directly to the handle, which is driven by the actuator and pivots the handle.

In a further embodiment, in the retracted position, the handle is pivoted such that an outer part of the handle closes the recess in the outer door panel. For example, the outer part of the handle is adapted to the surrounding contours of the vehicle door. The outer part of the handle can be attached to a base body of the handle such that the outer part of the handle only has to be adapted to the outer contour of the outer door panel and all other parts of the handle can remain the same. This creates a modular handle unit that can be used on a variety of vehicles. Preferably, the outer part of the handle may be made of a different material than the base body of the handle. For example, the outer part of the handle can be made of the same material as the outer door panel, so that there is no color difference between the outer door panel and the handle or the outer part of the handle.

The handle extends substantially in a longitudinal direction of the vehicle. This means that the main extension direction of the handle runs in the longitudinal direction of the vehicle. Furthermore, it is also possible that the main extension direction of the handle runs in a vertical direction or a transverse direction of the vehicle.

In a further embodiment, in the retracted position, the handle extends flush with a window shaft cover. As a result, in the retracted position, no interruption in the outer door panel is visible and the recess in the outer door panel is covered by the outer part of the handle, which has a geometry that corresponds to the window shaft cover. For example, the handle can then also be located near the B-pillar.

In a further embodiment, a camera is integrated into the handle. This makes it possible to dispense with the external rearview mirrors on the vehicle. The camera can therefore record at least rear traffic. The camera can be integrated into the handle in such a manner that the camera can pivot about an axle so that the camera can compensate for a blind spot. This is done by a control system evaluating the camera images and, for example, as soon as a vehicle overtakes, the camera follows the overtaking vehicle until the overtaking vehicle has passed the blind spot.

In addition, the camera can be controlled via other sensors or functions of the vehicle. For this purpose, the handle can always be in the retracted position when the vehicle is moving until a sensor, such as a radar sensor or lidar sensor, etc., detects an approaching vehicle. As soon as an approaching vehicle is detected, the handle with the camera pivots into the extended position so that a driver can see the traffic behind in the rearview mirror.

Furthermore, it is also possible that a further camera is arranged inside the passenger compartment of the vehicle, which detects the driver's eye movements and these are evaluated by a controller, so that the handle with the camera always pivots into the extended position and provides an image of the rear traffic when the driver wants to look in the rearview mirror. The rearview mirrors, for example, consist of displays that are arranged inside the vehicle.

Furthermore, it is possible for the handle with the camera to pivot into the extended position whenever the turn signal is activated. This means that the handle with the camera is only pivoted into the extended position when, for example, the driver needs to be informed of dangers or the driver wants to look at the rear traffic. In all other cases, the handle and camera can be in the retracted position, thereby reducing the vehicle's air resistance.

In a further embodiment, the handle on the vehicle door can open or close at least one other vehicle door or flap for the driver. This has the advantage that corresponding handles do not have to be provided on all vehicle doors or flaps. In addition, several vehicle doors and/or flaps can be operated from one point. For example, handles may only be provided on the front doors, i.e. the passenger door and the driver's door. These handles can be used, for example, to open and close the rear doors, a trunk lid, a fuel cap or a loading flap.

For example, at least one force sensor can be present in the handle, which can detect different actuations of the handle. For example, a short pull on the driver's door handle can open the driver's door, two pulls on the driver's door handle can open the driver's door and at least one other vehicle door, and a long pull on the driver's door handle can only open one other vehicle door, wherein the driver's door remains closed. It is also possible for the controller to enable a self-learning mode to be activated, and the operator can decide for themself which actuation sequence should be stored for each vehicle door and for which function.

For example, at least one sensor is arranged in the handle to detect an operator request. For example, the at least one sensor can be a force sensor, for example a strain gauge, a capacitive sensor and/or an NFC sensor. Furthermore, the handle can have lighting and/or a module for haptic feedback, for example to haptically confirm an operator's input.

### BRIEF DESCRIPTION OF THE DRAWINGS

The present disclosure is described in more detail below using embodiments with reference to the accompanying figures. In the figures:

FIG. 1 shows a schematic view of a handle in the retracted position;

FIG. 2 shows a schematic view of a handle in the extended position;

FIG. 3 shows a view of an actuator in a retracted position;

FIG. 4 shows a view of an actuator in an extended position;

FIG. 5 shows a view of an actuator in a retracted position;

FIG. 6 shows a section through the vehicle door;

FIG. 7 shows a view of an actuator in an extended position;

FIG. 8 shows a door handle in the extended position;

FIG. 9 shows a section through a vehicle door;

FIG. 10 shows a section through a vehicle door;

FIG. 11 shows a flexible printed circuit board; and

FIG. 12 shows a section through a flexible printed circuit board.

### DETAILED DESCRIPTION

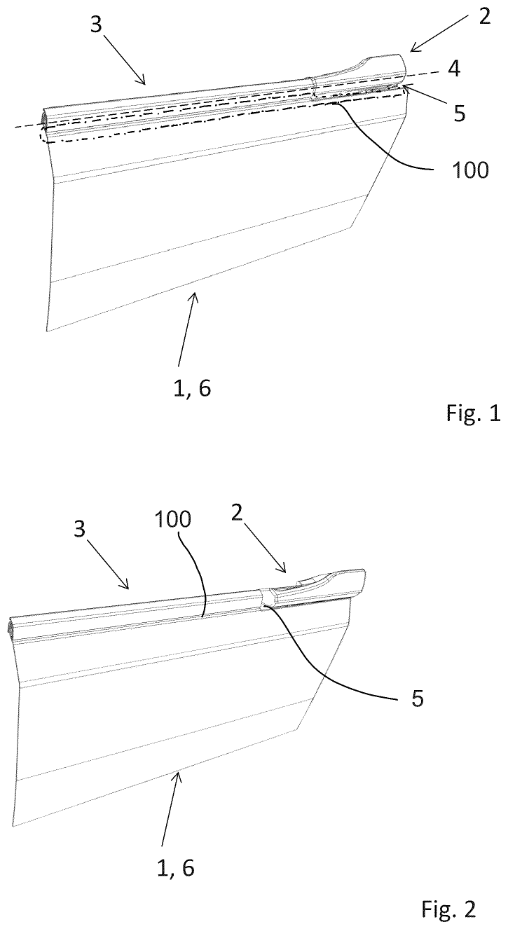

FIG. 1 shows a vehicle door 1 with a handle 2 which is in a retracted position and is configured to pivot about an axle 4 which extends substantially in a longitudinal direction of the vehicle. Only a part of the vehicle door is shown as the part of a window frame 100 which extends vertically upwards and the upper, horizontal part of the window frame 100 and the front end of the vehicle door with the hinge are not shown.

The outer door panel has a recess 5 for handle 2. More precisely, the window frame 100, i.e. the part of the vehicle door (seen from the outside) that defines the window opening and adjoins the closed window from the outside, has the recess 5.

Handle 2 can be pivoted into an extended position or a retracted position by an actuator 7. Recess 5 is arranged in an area of a window frame and handle 2 is received in recess 5. In the retracted position, handle 2 is at least partially pivoted behind the outer door panel. In the retracted position, handle 2 is flush with a window shaft cover 3, as a result of which no interruption is visible in the outer door panel 6, and recess 5 in the outer door panel 6 is covered by an outer part 8 of handle 2, which has a geometry that corresponds to window shaft cover 3. As the window shaft cover 3 partially covers the window frame 100, the window frame 100 in FIG. 1 is framed with a dotted line. It can be seen that at the rear end there is a step in the framed area, which is created by the recess 5 in the otherwise horizontally extending window frame 100.

FIG. 2 shows a handle 2 in the extended position. Here, the handle is pivoted in such a manner that handle 2 can be grasped at least with the fingers and enables operation. In the extended position, recess 5 is covered by handle 2. The handle 2 can be located near the B-pillar.

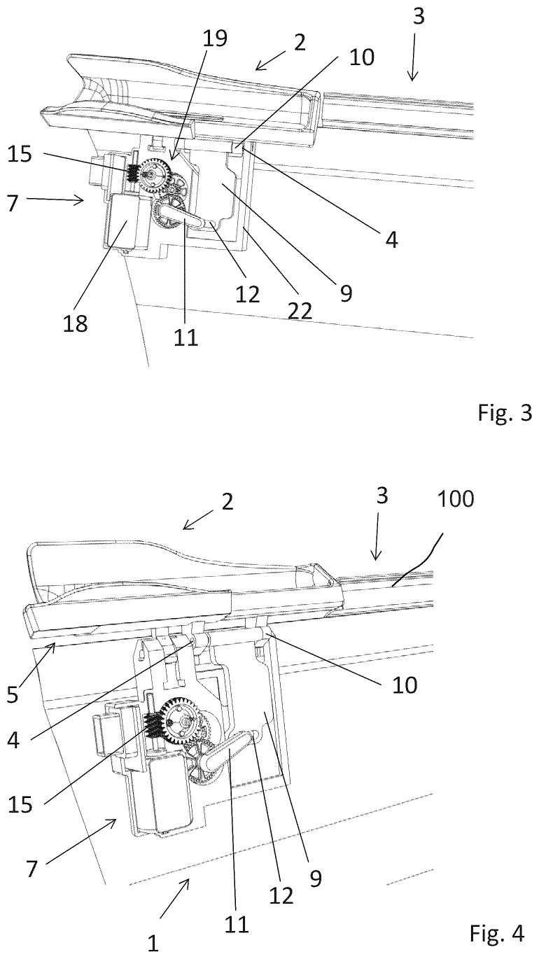

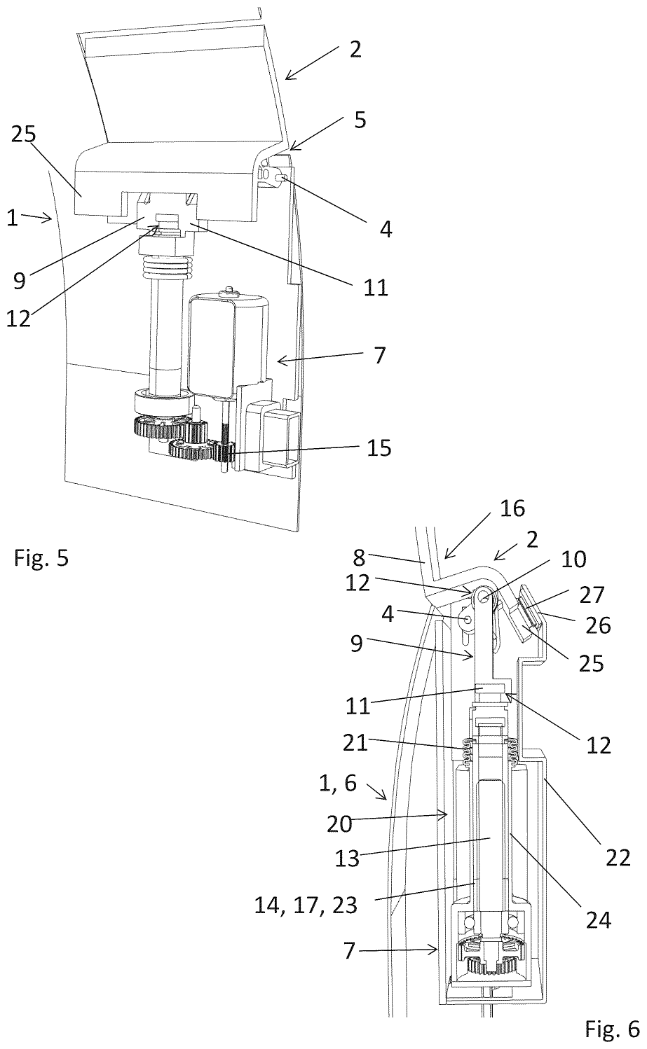

FIG. 3 shows a view of an actuator 7 in a retracted position of handle 2, wherein the actuator is arranged on an inner side of the vehicle door. Actuator 7 has a motor 18, a worm gear 15 and a reduction gear 19. Connecting element 11 is connected to the reduction gear 19. For this purpose, transmission element 9 has an elongated hole 12 in which connecting element 11 can move in order to pivot transmission element 9 or handle 2 from a retracted position to an extended position. A linear movement of the transmission element 9 is achieved by connecting element 11. Connecting element 11 is guided in housing 22.

FIG. 4 shows actuator 7 or handle 2 in the extended position.

FIG. 6 shows a section through vehicle door 1. Actuator 7 is arranged spatially separated from handle 2 and pivots handle 2 by actuating a transmission element 9. Transmission element 9 is connected to handle 2 and actuator 7. For this purpose, handle 2 has at least one connecting element 10 in the form of an axle. Actuator 7 also has a connecting element 11 for transmission element 9. Connecting element 11 of actuator 7 is connected to transmission element 9 by a positive connection. Transmission element 9 has a receptacle 12 near its two end faces for the connecting elements 10, 11 of handle 2 and actuator 7.

Handle 2 consists of a base body 16 and an outer part 8, wherein base body 16 and outer part 17 can be made in one piece or can be formed in two parts. In a two-part embodiment of base body 16 and outer part 8 of handle 2, outer part 8 of handle 2 is attached to the base body 16 by a force-fitting connection, such as clips or latches.

Actuator 7 can be a spindle drive 20, which consists of a spindle 13 and a spindle nut 14, wherein spindle 13 or spindle nut 14 is driven via a worm gear 15. Spindle nut 14 can also be a thread in a pipe 17, wherein pipe 17 is retracted and extended by spindle 13. The transmission element 9 is connected either to spindle 13 or spindle nut 14. Receptacle 12 or handle 2 can be mounted in such a manner that handle 2 can be pivoted relative to receptacle 12.

Actuator 7 is arranged below handle 2 and between the outer door panel 6 and an inner door lining. Actuator 7 moves the transmission element 9 in a linear, almost vertical direction with respect to the longitudinal direction of the vehicle.

Spindle drive 20 can have a seal 21 which seals spindle drive 20 against external influences. Seal 21 is arranged between a spindle drive housing 24 and an extendable part 23 of spindle drive 20.

Furthermore, handle 2 can have a stop 25 which points towards the side of an interior lining of the vehicle door 1 and can be connected to the base body 16 of handle 2. Stop 25 and base body 16 can be connected in one piece. For example, handle 2 has an S-shaped or Z-shaped cross-section. Outer part 8 of handle 2 points in the direction of an outer side of the vehicle door 1 or in the direction of the outer door panel 6, and stop 25 points towards the inner side of the vehicle door 1 or towards an interior of the vehicle. On housing 22, a stop surface 26 is provided for stop 25, on which a sensor 27 or a switch 27 is arranged. In the extended position of handle 2, stop 25 does not contact stop surface 26. Only when an operator pulls on handle 2 does stop 25 come into contact with stop surface 26 or with sensor 27 or switch 27 and triggers a sensor signal or a switch signal which unlocks vehicle door 1 and enables it to be opened. For example, sensor 27 is a strain gauge 27, a capacitive sensor 27 or an inductive sensor 27. Furthermore, it is also possible that sensor 27 only detects an approach of stop 25 to the stop surface 26. This also allows contactless detection of stop 25. For this purpose, for example, a metal can be applied to stop 25, which is detected by sensor 27.

In the retracted position, handle 2 is pivoted such that an outer part 8 of handle 2 closes recess 5 in the outer door panel 6. Here, the outer part 8 of handle 2 is adapted to the surrounding contours of vehicle door 1. Furthermore, it is also possible for handle 2 to be pivoted completely between the outer door panel 6 and the inner door panel and for an additional flap to close the recess in the outer door panel. For this purpose, a flap is mounted in a guided manner on the inner side of the outer door panel so that when handle 2 is in the extended position, the flap is arranged in the non-visible area of the outer door panel. Guide rails for the flap are arranged on the inner side of the outer door panel. Thus, the guide rails for the flap run inside the vehicle and are invisible from the outside. This protects the guide rails from external influences. The flap moves perpendicular to a longitudinal direction of the vehicle.

In a first position, the flap is flush with an outer side of the door outer panel, which corresponds to the retracted position of handle 2. Furthermore, in a second position, the flap is at least partially, in particular completely, moved behind the outer door panel, which corresponds to the extended position of handle 2. Thus, in the second position, the outer side of the flap and the inner side of the door outer panel are opposite each other. This prevents the flap from coming into contact with the vehicle and causing damage, such as scratches or dents, if a person bumps into the flap. Furthermore, the flap cannot break off.

The flap is moved by an actuator, wherein the guide rails have grooves which are arranged parallel to each other, wherein the open sides of the grooves are arranged opposite each other. Pins are arranged on the flap, which engage in the grooves of the guide rails. For example, the pins are connected to the flap in one piece and protrude laterally beyond the flap. For example, the flap has at least two pins.

At least one sensor is arranged on at least one guide rail. In the closed position of the flap, the at least one sensor can be arranged in the vicinity of the pins of the flap.

In order to open the flap or to pivot handle 2 from the retracted position to the extended position, it can be provided that a certain pressure must be exerted on the flap and a defined threshold value must be exceeded in order for the flap to be moved from a first position to a second position and in order to pivot the handle from the retracted position to the extended position. Alternatively, this can also be done using a remote control.

To pivot the handle from the extended position to the retracted position, this can be done automatically after a defined period of time, by a movement pattern, such as swiping over the handle, opening the door, starting an engine or locking the vehicle.

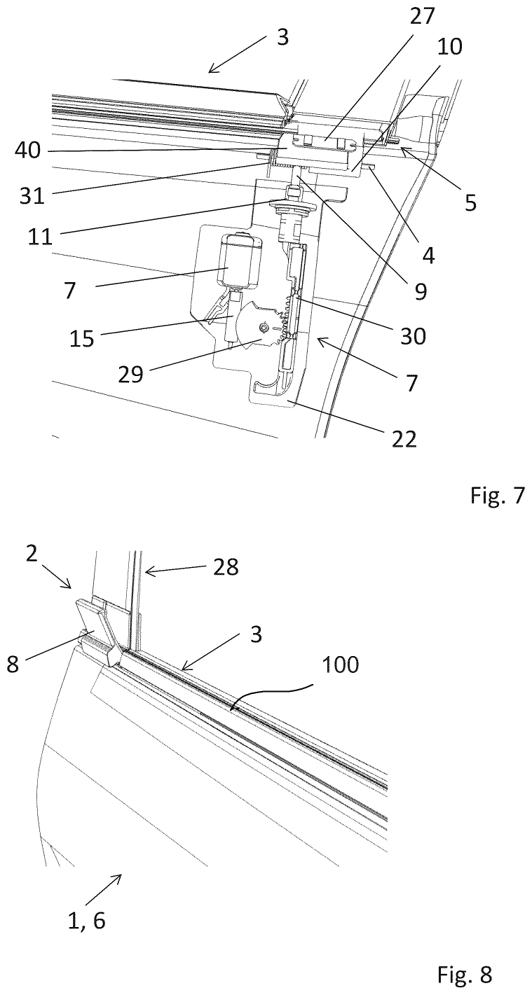

FIGS. 7 and 8 show a handle 2 which is arranged in the vicinity of a B-pillar 28. In the retracted position, the handle is flush with B-pillar 28 and window shaft cover 3. In the extended position, handle 2 is pivoted into an actuation position in which handle 2 can be grasped by an operator.

The mechanism for pivoting handle 2 consists of an actuator 7 with a worm gear 15 and a gear wheel 29 or a reduction gear 19, wherein gear wheel 29 or reduction gear 19 is driven by worm gear 7. Gear wheel 29 drives a rack 30 which is connected to the transmission element 9 via a connecting element 11. Transmission element 9, in the form of a pin, pivots handle 2 from a retracted position to an extended position. For this purpose, handle 2 has a stop surface 40 which is connected to transmission element 9 or is in contact with transmission element 9. Sensors 27 can be arranged on the stop surface 40 of handle 2, which detect an actuation of handle 2 by an operator. To pivot handle 2 back into the retracted position, the handle has a return element 31 in the form of a spring 31. Return element 31 is arranged on axle 4 of handle 2 and is preloaded when handle 2 is swiveled into the extended position. As soon as actuator 7 moves back into the retracted position, handle 2 is pivoted into the retracted position, at least with the support of return element 31.

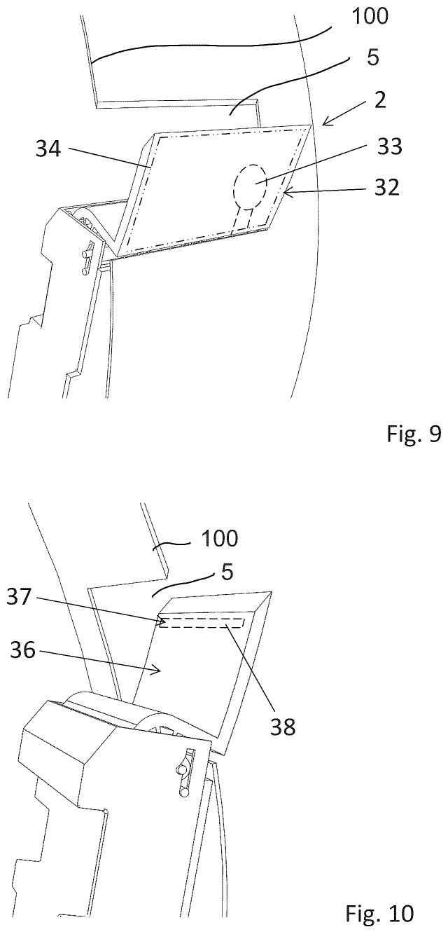

According to FIGS. 9 and 10, at least one sensor 32 can be arranged in handle 2 in order to detect an operator request. For example, the at least one sensor 32 can be a force sensor, for example a strain gauge, a capacitive sensor 33 and/or an NFC sensor 34 with at least one NFC antenna. Sensor 32 can be arranged in the outer part 8 of handle 2 and/or in the base body 16 of handle 2. The outer part 8 of handle 2 may also be a cover which at least partially encloses base body 16 of handle 2.

The at least one sensor 32 can be arranged on a flexible printed circuit board 35. A plurality of sensors 32 can be arranged on the flexible circuit board 35, for example at least two. The first capacitive sensor 33 and the NFC sensor 34 are arranged such that an operator can activate the at least one sensor 32 in the retracted position of handle 2, for example by approaching handle 2 or by actuating handle 2. Thus, at least one sensor 32 is arranged in the area of the outer part 8 of handle 2, for example sensor 32 is oriented such that the detection area of sensor 2 faces an outer side.

In addition, a further sensor 37 can be arranged on flexible circuit board 35. When the flexible circuit board 35 is installed, sensor 37 is located opposite sensor 32. Thus, the detection area of sensor 37 is oriented towards an interior of the vehicle. As a result, sensor 37 is arranged on an inner side 36 of handle 2. It is thus possible that in the extended position of handle 2 a gripping action of an operator can be detected, for example the fingers which are gripping handle 2. For example, a second capacitive sensor 38 is provided for this purpose.

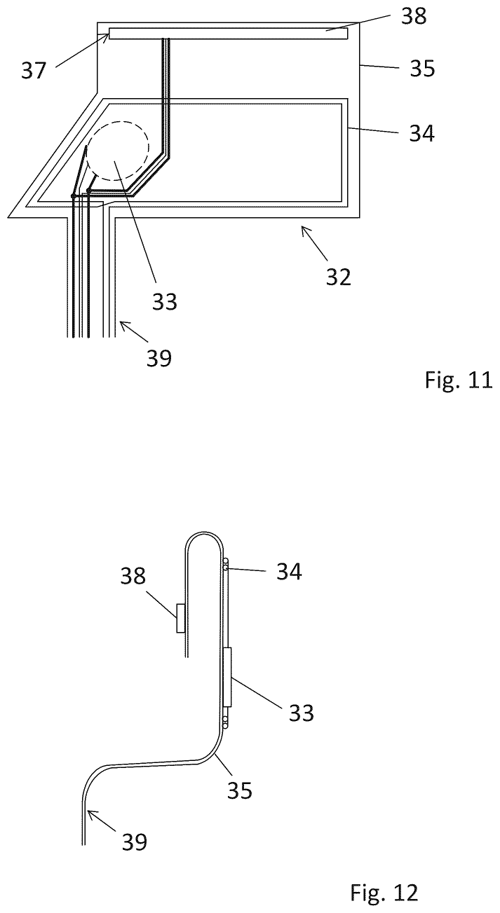

FIG. 11 shows a flexible circuit board 35 with the sensors 32, 33, 34, 37, 38 arranged thereon. The NFC antenna of NFC sensor 34 is placed on or in flexible circuit board 35 to increase the surface area and can be impedance controlled. The capacitive sensors 33, 38 are integrated as copper plates in flexible circuit board 35.

The flexible circuit board 35 is connected to a controller, not shown, via a connection 39. This results in a cost-effective solution with minimal use of connecting material (e.g. wires, connectors, etc.). When using a flexible circuit board 35, it is possible to adapt the shape of flexible circuit board 35 to the shape of handle 2. This allows handle 2 to have a very compact shape.

FIG. 12 shows a section through a flexible circuit board 35, wherein flexible circuit board 35 is adapted to the shape of a handle 2. Here, it can be seen that the first capacitive sensor 33 and the NFC sensor 34 are arranged on one side of handle 2 and the second capacitive sensor 38 is arranged on an opposite side of handle 2.

For example, flexible circuit board 35 with sensors 32, 33, 34, 37, 38 is connected to handle 2, for example to the outer part 8 of handle 2, and then overmolded.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### LIST OF REFERENCE SIGNS

1 vehicle door
2 handle
3 window shaft cover
4 axle
5 recess
6 outer door panel
7 actuator
8 outer part of the handle
9 transmission element
10 connecting elements of the handle
11 connecting elements of the actuator
12 image of the transmission element
13 spindle
14 spindle nut
15 gear of the engine
16 base body of the handle
17 pipe of the spindle nut
18 engine
19 reduction gear
20 spindle drive
21 seal of the spindle drive
22 housing
23 extendable part of the spindle drive
24 spindle drive housing
25 stop of the handle
26 stop surface of the housing
27 sensor/switch
28 B-pillar
29 gear wheel
30 rack
31 reset element
32 sensor
33 first capacitive sensor
34 NFC sensor
35 flexible circuit board
36 inner side of the handle
37 additional sensor
38 second capacitive sensor
39 connection of the circuit board
40 stop surface of the handle
100 window frame

1. A vehicle door, comprising:
a vehicle door lock to be actuated, which interacts with a handle and is configured to pivot about an axle which extends substantially in a longitudinal direction of the vehicle, and
a recess in an outer door panel for the handle,
wherein the handle pivots into an extended position or into a retracted position via an actuator,
wherein the recess is arranged in an area of a window frame and the handle is received in the recess, and
wherein, in the retracted position, the handle pivots at least partially behind the outer door panel.

2. The vehicle door according to claim 1, wherein there is no mechanical connection between the handle and the electric vehicle door lock.

3. The vehicle door according to claim 1, wherein the actuator is either attached directly to the handle or integrated into it.

4. The vehicle door according to claim 1, wherein the actuator is arranged spatially separated from the handle and the handle is pivoted by actuating a transmission element.

5. The vehicle door according to claim 4, wherein the transmission element rotates about an axle.

6. The vehicle door according to claim 4, wherein the transmission element is moved linearly.

7. The vehicle door according to claim 1, wherein the actuator has a spindle drive.

8. The vehicle door according to claim 1, wherein, in the retracted position, the handle is pivoted such that an outer part of the handle closes the recess in the outer door panel.

9. The vehicle door according to claim 8, wherein the outer part of the handle is adapted to the surrounding contours of the vehicle door.

10. The vehicle door according to claim 1, wherein the handle extends substantially in a longitudinal direction of the vehicle.

11. The vehicle door according to claim 1, wherein the handle extends substantially in a vertical direction of the vehicle.

12. The vehicle door according to claim 1, wherein the handle extends substantially in a transverse direction of the vehicle.

13. The vehicle door according to claim 1, wherein, in the retracted position, the handle extends flush with a window shaft cover.

14. The vehicle door according to claim 1, wherein a camera is integrated into the handle.

15. The vehicle door according to claim 14, wherein the camera records at least rear traffic.

16. The vehicle door according to claim 1, wherein the handle on the vehicle door can open or close at least one other vehicle door or flap for the driver.
